(19) United States
(12) Patent Application Publication
(10) Pub. No.: US 2017/0357032 A1
(43) Pub. Date: Dec. 14, 2017

(54) Compositions and Methods for Improving Adhesion with a Sputtered Coating

(71) Applicant: ESSILOR INTERNATIONAL (COMPAGNIE GENERALE D'OPTIQUE), Charenton-le-Pont (FR)

(72) Inventor: Robert Valeri, Dallas, TX (US)

(21) Appl. No.: 15/540,155

(22) PCT Filed: Dec. 30, 2014
(86) PCT No.: PCT/IB2014/003140

§ 371 Date: Jun. 27, 2017

(51) Int. Cl. G02B 1/14; C08J 7/04

(52) U.S. Cl. CPC G02B 1/14; C08J 7/045

(57) ABSTRACT

Hard coating compositions and articles coated with said hard coating compositions are described. The coating compositions include at least a first layer as a hard coating to which is adhered a sputtered silicon containing layer, wherein the hard coating is formed with an unhydrolyzed alkoxysilane monomer cured cationically to increase a total amount of hydroxyl functional groups available in the first layer upon curing. The increased hydroxyl functional groups in the hard coating interact with the sputtered silicon containing layer and promote adherence between the hard coating and the sputtered silicon containing layer.

### TECHNICAL FIELD

The present invention relates to methods and compositions for improving adhesion of a sputtered coating, said sputtered coating provided on a functional coating of a substrate, such as a hard coat on an ophthalmic or optical substrate.

### BACKGROUND

Deposition of a coating or layer by sputtering involves a physical vapor deposition (PVD) process in a vacuum chamber in the presence of an inert and/or reactive gas. The sputtering process provides a thin film, as the coating or layer, on a surface of a substrate. The substrate, such as an ophthalmic or optical substrate, is often one having one or more functional layers on its surface, thus, the sputtered layer is actually applied to a functional layer on some or all of the surface of the substrate. Good adhesion of the sputter applied layer to the functional layer on ophthalmic or optical substrates has proven difficult. For example, common commercial UV curable hard coatings do not adhere well to sputter applied antireflective coatings. The poor adherence has been found in hard coatings comprising acrylic, polyurethane, and other common photo-curable functional coatings. Failure can be found in the form of stress crack defects and in adherence, in which adhesion between the sputtered layer and said functional coating is inconsistent or not lasting. Thus, alternative functional coating compositions are needed that improve the adhesion between sputter applied coatings and the immediately adjacent functional coatings of the substrate, such as an ophthalmic or optical substrate. These coating compositions should remain optically transparent, when desired, and provide other performance properties as needed for the ophthalmic or optical substrates.

### SUMMARY

Described herein are coating compositions for a hard coating that overcome obstacles described above. The described coating compositions have been designed to influence and improve adhesion of a sputtered applied coating, such as an antireflective (AR) layer or coating, to the described hard coating when cured. Adhesion performance was found to be directly influenced by the chemical composition of the hard coating. Each of the described hard coating compositions are improved coating compositions that promote adhesion of the sputtered coating when applied to the hard coating. The described coating composition all performed better with regard to adhesion between said composition and the sputtered layer as compared with alternative and commercial hard coatings, even when the same surface preparations and sputtering processes were performed.

In one or more embodiments are compositions provided as hard coatings for an ophthalmic or optical article. The compositions promoting adhesion with a sputtered silicon containing layer applied thereto. The composition comprise an acrylic monomer and a first material as a source of hydroxyl functional groups when the composition is cured, the first material comprising an unhydrolyzed alkoxysilane monomer cured cationically and in an amount that increases a total amount of hydroxyl functional groups in the composition. The compositions may further comprise a cationic initiator that is photoactivatable. The compositions may further comprise a second material as a source of further hydroxyl functional groups for the composition upon curing, the second material including one or more of silicon oxide particles and an aliphatic epoxy. Further additives found in said coating compositions may also be included. The unhydrolyzed alkoxysilane monomer includes at least one of a reactive group as an epoxy alkoxy silane, cycloaliphatic epoxy silane, and/or vinyl alkoxy silane. The composition may further comprise a free radical initiator that is photoactivatable. The first material may be in an amount that is at least about 5 wt. % or greater and up to about 60 wt. %. The second material when provided may be in an amount of up to about 30 wt. %. The silicon oxide particles may be provided as a dispersion, and the dispersion may comprise any one or more of a group selected from a solvent, an acrylic monomer, and an epoxy monomer. The sputtered silicon containing layer may be one of a stack of light absorptive antireflective layers in which a layer in immediate contact with the hard coating is silicon nitride. The sputtered silicon containing layer may be one of a stack of light absorptive antireflective layers in which the sputtered silicon containing layer in contact with the hard coating is silicon oxide. The antireflective layers may also comprise any one of SiO, SiO₂, Si₃N₄, TiO₂, TiN, ZnO, ZrO₂, Al₂O₃, MgF₂, and Ta₂O₅, as representative examples, requiring one or more reacting gases, such as N₂ and O₂ in the sputtering process.

Further described are methods of promoting and improving adhesion between a sputtered silicon containing layer to a first layer as a hard coating by including an unhydrolyzed alkoxysilane monomer cured cationically in a composition forming the hard coating and increasing a total amount of hydroxyl functional groups in the composition upon curing, the increased hydroxyl functional groups interacting with the sputtered silicon containing layer and promoting adherence there between. The increased amount of hydroxyl functional groups available in the composition upon curing is comparable to alternative or commercial hard coatings prepared without the increased amount of hydroxyl functional groups.

An ophthalmic or optical article is also described. Said article serves as a substrate and further comprises at least a first layer as a hard coating to which is adhered a sputtered silicon containing layer, wherein the first layer is formed with an unhydrolyzed alkoxysilane monomer cured cationically to increase a total amount of hydroxyl functional groups available in the first layer upon curing, the increased hydroxyl functional groups for interacting with the sputtered silicon containing layer and promoting adherence between said layers. The unhydrolyzed alkoxysilane monomer cured cationically includes at least one of a reactive group as an epoxy alkoxy silane, cycloaliphatic epoxy silane, and vinyl alkoxy silane. The hydroxyl functional groups may be further provided by a second material comprising one or more of silicon oxide particles and an aliphatic epoxy. In some embodiments, the hard coating is formed from a composition comprising the unhydrolyzed alkoxysilane monomer cured cationically, an acrylic monomer and a free radical initiator that is photoactivatable. The unhydrolyzed alkoxysilane monomer or combination of monomers are typically in an amount that is at least about 5 wt. % or greater and up to about 60 wt. % of the hard coating composition. The sputtered silicon containing layer may be a multi-layer antireflective coating. The sputtered silicon containing layer in contact with the hard coating may contain silicon nitride or silicon oxide.

More details relating to the various embodiments of the invention are further described in the detailed description.

### DETAILED DESCRIPTION

Although making and using various embodiments are discussed in detail below, it should be appreciated that as described herein are provided many inventive concepts that may be embodied in a wide variety of contexts. Embodiments discussed herein are merely representative and do not limit the scope of the invention.

Described herein are compositions and method of manufacturing and use of said compositions to promote robust adhesion of the hard coating formed by the composition to another coating or layer applied to the hard coating by sputtering. The robust adherence described herein has not previously been observed with alternative hard coating compositions, including commercial hard coatings, including those formed with an acrylic-based resin, polyurethane-based resin, or other photo-curable polymer based resins because their chemistries don't provide sufficient functional groups upon curing for bonding to sputter applied coatings, such as antireflective (AR) coatings.

The chemical compositions of the described hard coatings, confirmed experimentally and by FTIR analysis, adhered better with sputter applied AR coatings than the above described alternative hard coating that do not contain the described chemical compositions. Said improved adherence is associated with contributions of one or more raw materials included in the novel chemical compositions described herein. At least one raw material will be a multifunctional component so that it not only provides features for adherence with a sputtered AR coating, it is also crosslinkable for forming a crosslinked film or hard coating.

The chemical compositions described herein include one or more raw materials. At least one of the raw materials is an unhydrolyzed alkoxysilane monomer that is curable by a cationic initiator. This contrasts with alternative hard coating compositions in which the alkoxysilane monomer is hydrolyzed (or includes hydrolyzates), or at least a portion of the alkoxysilane monomer is hydrolyzed. The unhydrolyzed alkoxysilane monomer described herein is multifunctional as further described below, so that it not only supports adhesion of and to the AR coating, it assists in formation of a crosslinked film or hard coating. This first raw material includes at least one reactive group that may be provided in the form of an epoxy alkoxy silane, a cycloaliphatic epoxy silane, and/or a vinyl alkoxy silane. Said unhydrolyzed alkoxy silane may further comprise at least one alkyl group and there may be more than one of the epoxy, vinyl or cycloaliphatic epoxy groups. A useful alkoxysilane may have a structure as depicted in formula (I) below.

RₙSi(OR′)₄₋ₙ (I)

In formula I, the R is an epoxy, cycloepoxy, or vinyl (containing an alkyl group); n is between 1 and 3 and R′ is a lower, linear or branched alkyl group, generally with 1 to 4 carbons.

Epoxy alkoxy silanes having a glycidoxy group are well suited for the described compositions, such as for example, glycidoxy methyl trimethoxysilane, glycidoxy methyl triethoxysilane, glycidoxy methyl tripropoxysilane, α-glycidoxy ethyl trimethoxysilane, α-glycidoxy ethyl triethoxysilane, β-glycidoxy ethyl trimethoxysilane, β-glycidoxy ethyl triethoxysilane, β-glycidoxy ethyl tripropoxysilane, α-glycidoxy propyl trimethoxysilane, α-glycidoxy propyl triethoxysilane, α-glycidoxy propyl tripropoxysilane, β-glycidoxy propyl trimethoxysilane, β-glycidoxy propyl triethoxysilane, β-glycidoxy propyl tripropoxysilane, γ-glycidoxy propyl trimethoxysilane, γ-glycidoxy propyl triethoxysilane, γ-glycidoxy propyl tripropoxysilane, γ-glycidoxypropyl pentamethyl disiloxane, γ-glycidoxypropyl methyl diisopropenoxy silane, γ-glycidoxypropyl methyl diethoxysilane, γ-glycidoxypropyl dimethyl ethoxysilane, γ-glycidoxypropyl diisopropyl ethoxysilane, γ-glycidoxypropyl bis (trimethylsiloxy) methylsilane and mixtures thereof.

Representative examples of a vinyl alkoxy silane are vinyl trimethoxy silane, vinyl methyldimethoxy silane, vinyl triethoxy silane, and vinyl tris (2-methoxyethoxy) silane, vinyl tris isopropoxy silane, vinyl dimethyl ethoxy silane, vinyl methyl diethoxy silane, and the like.

Representative examples of cycloaliphatic epoxy silanes are hexamethylcyclotrisilane beta-(3,4-epoxycyclohexyl)-ethyl trimethoxysilane, beta-(3,4-expoxycyclohexyl)-ethyl methyl dimethoxysilane, beta-(3,4-expoxycyclohexyl)-ethyl methyl diethoxysilane, beta-(3,4-epoxycyclohexyl)-ethyl triethoxysilane and the like.

All the above representative examples are understood to be non-limiting.

One or more unhydrolyzed alkoxysilane is present in the coating compositions at a weight concentration (solids basis) of about 10% to about 70%. In some embodiments, the amount of the unhydrolyzed alkoxysilane will be about 20% to about 50% of solids. For example, when only unhydrolyzed alkoxysilanes (first material) are present, the unhydrolyzed alkoxysilane will often comprise at least about 15 wt. % of the composition. In some embodiments, when only unhydrolyzed alkoxysilanes (first material) are present, the unhydrolyzed alkoxysilane will generally comprise at least about 19 wt. % of the composition. In some embodiments, there are at least two unhydrolyzed alkoxysilanes present in the coating composition. In some embodiment, there are at least three unhydrolyzed alkoxysilanes present in the coating composition. Typically there is not more than four unhydrolyzed alkoxysilanes present in the coating composition, in which each unhydrolyzed alkoxysilane is from a separate source.

The chemical compositions described herein may further comprise one or more additional raw materials selected from one or more of silicon oxide particles and aliphatic epoxies. The amount of the second material may be up to 30 wt. % of the composition. Addition of a second raw material may reduce the total amount of the first raw material

The silicon oxide particles are typically provided in a dispersion.

Silicon oxide particles may be dispersed in a solvent, an acrylic monomer, or an epoxy monomer (which may be the aliphatic epoxy or cycloaliphatic epoxy). Examples of such dispersions include ones comprising colloidal silica sols in which silicon oxide containing nanoparticles are provided in a base resin of hexanediol diacrylate, or in which silicon oxide containing nanoparticles are provided in a base resin of trimethylolpropanetriacrylate (TMPTA), or in which silicon oxide containing nanoparticles are provided in a base resin of alkoxylated pentaerythritol tetraacrylate. Additional base resins suitable for dispersing silicon oxide particles or silicon oxide containing particles are tripropylene glycol diacrylate (TPGDA), and ethoxylated trimethylol propane triacrylate (TMPEOTA), and cycloaliphatic epoxy resin (EEC), as further representative examples. The dispersion itself may have at least 50 wt. % silicon oxide, or the amount of silicon oxide in the dispersion may be more or less than 50 wt. %. Often, the amount of silicon oxide in the particles is at least about 50 wt. % or greater. The mean nanoparticle size may be approximately 20 nm, or approximately 30 nm, or less than 30 nm, or may be any range generally between about 1 nm and 1 mm. Particle sizes are important for transparency. Thus, for a composition prepared as a transparent coating, it is preferred that the mean average particle size is less 50 nm or less, or is 30 nm or less, or is 25 nm or less, or is 20 nm or less.

The aliphatic epoxy is selected from a glycidyl epoxy resin (monofunctional, difunctional, or higher functionality, including from a family of alkoxysilane epoxy), and a cycloaliphatic epoxide (having one or more cycloaliphatic rings to which an oxirane ring is fused). The aliphatic epoxies may be completely saturated hydrocarbons (alkanes) or may contain double or triple bonds (alkenes or alkynes). They can also contain rings that are not aromatic.

In general, any of the described chemical compositions will, at a minimum, contain at least one first raw material (unhydrolyzed alkoxysilane). Any combination of the at least one first raw material and/or another at least one first raw material or one or more second raw materials (one or more of silicon oxide particles, and aliphatic epoxy) are suitable for the compositions described herein, provided the first raw material and the second raw material are included in the amounts described above. For example, in some embodiments, there will be the at least one first raw material as well as at least one second raw material present in the coating composition. In some embodiments, there will be at least two first raw materials as well as at least one second raw material present in the coating composition. In some embodiments, there will be at least one first raw material as well as at least two second raw materials present in the coating composition.

For the described chemical compositions, the inclusion of the at least one raw material introduces and expands the amount of hydroxyl (—OH) groups available in the composition. The hydroxyl groups are created by functional groups selected from silanol groups (Si—OH) or epoxy groups (C—OH) and are present in the selected raw materials disclosed herein. Said functional groups are reconfigured when the composition undergoes cross-linking, which occurs with addition of an appropriate catalyst (initiator) and/or hardener. For example, during crosslinking in the presence of a sufficient amount of a cationic initiator, there will be opening of the epoxy ring of an epoxysilane that will yield hydroxyl groups. In another example, during crosslinking, alkoxysilane reactive groups will yield free hydroxyl groups from hydrolysis when in the presence of a sufficient amount of a cationic initiator that provides Brönsted acids with photolysis of its onium salt. As such, by providing at least one or a combination of the described additional raw materials and in the presence of a cationic initiator, the number of unreacted hydroxyl groups in the coating composition is increased, which unexpectedly provided an improved hard coating having not only the required hard coating properties, but also the added advantage of providing increased adherence with a sputtered coating applied on said hard coating. The findings overcome the challenges that have been found to date in which there has been, to date, poor or incomplete adherence between a conventional hard coating (acrylic based, polyurethane based, and other common photo-curable functional coatings) and a sputtered coating applied to that hard coating.

Improved adhesion of a silicon containing sputtered coating to the hard coatings described herein is due in part to the increased presence of hydroxyl (—OH) groups in the described chemical compositions as well as increasing the number of unreacted hydroxyl groups in the cured composition. Curing of the described compositions occurs in the same manner known in the art, such as by use of a cationic and photoactivatable initiator (photoinitiator or photopolymerization initiator) that is activated by some form of radiation.

Useful cationic initiators include ones having or containing an aromatic onium salt, including salts of Group Va elements (e.g., phosphonium salts, such as triphenyl phenacylphosphonium hexafluorophosphate), salts of Group VIa elements (e.g., sulfonium salts, such as triphenylsulfonium tetrafluoroborate, triphenylsulfonium hexafluorophosphate and triphenylsulfonium hexafluoroantimonate, triarylsulfoniumhexafluorophosphate, triarylsulfoniumhexafluoroantimonate), and salts of Group VIa elements (e.g. iodonium salts, such as diphenyliodonium chloride and diaryl iodonium hexafluoroantimonate). Additional examples may be found in U.S. Pat. No. 4,000,115 (e.g., phenyldiazonium hexafluorophosphates), U.S. Pat. No. 4,058,401, U.S. Pat. No. 4,069,055, U.S. Pat. No. 4,101,513, and U.S. Pat. No. 4,161,478, all of which are hereby incorporated by reference in their entirety. These examples are understood to be non limiting. The amount of cationic photoinitiator may be up to 10 wt. % based on epoxy content. The amount of cationic photoinitiator may be from about 3 wt. % to about 8 wt. %.

Photopolymerization may be performed by actinic irradiation. The actinic irradiation may be ultraviolet radiation, such as UV-A radiation. In one or more embodiments, the described chemical coating composition is a UV curable hard coating composition.

Thermal polymerization is not typically required. Heat during radiation curing promotes condensation between —OH groups, thus no thermal catalysis are generally included. They may be included in some embodiments. Thermal polymerization initiating agents would generally be in the form of peroxides, such as benzoyl peroxide, cyclohexyl peroxydicarbonate and isopropyl peroxydicarbonate.

The described coating compositions may also include the addition of a free-radical initiator, which may be photoactivatable and/or thermally activated. This initiator will enhance crosslinking of ethylenically unsaturated monomers. Representative free-radical initiators that are photoactivatable include but are not limited to xanthones, haloalkylated aromatic ketones, chloromethylbenzophenones, certain benzoin ethers (e.g, alkyl benzoyl ethers), certain benzophenone, certain acetophenone and their derivatives such as diethoxy acetophenone and 2-hydroxy-2-methyl-1-phenylpropan-1-one, dimethoxyphenyl acetophenone, benzylideneacetophenone; hydroxy ketones such as (1-[4-(2-hydroxyethoxy)-phenyl]-2-hydroxy-2-methyl-1-propane- 1-one) (Irgacure® 2959, last registered with BASF SE Company, Germany), 2,2-di-sec-butoxyacetophenone, 2,2-diethoxy-2-phenyl-acetophenone, 1-hydroxy-cyclohexyl-phenyl-ketone (e.g., Irgacure® 184) and 2-hydroxy-2-methyl-1-phenylpropane-1-one (e.g., Darocur® 1173, last registered with Burrough Wellcome, N.C., US); alpha amino ketones, particularly those containing a benzoyl moiety, otherwise called alpha-amino acetophenones, for example 2-methyl 1-[4(methylthio)phenyl]-2-morpholinopropan-1-one (Irgacure® 907), (2-benzyl-2-dimethyl amino-1-(4-morpholinophenyl)-butan-1-one (Irgacure® 369), and benzil ketals, such as ethyl benzoin ether, isopropyl benzoin ether. In some embodiments, the free radical initiator may be selected from one or more of α,α-dimethoxy-α-phenyl acetophenone, and 2-hydroxy-2-methyl-1-phenylpropane-1-one, 1-hydroxycyclohexyl phenyl ketone, and 2,2-dimethoxy-1,2-diphenylethane-1-one [sic]. Further representative free radical photoinitiators include but are not limited to acylphosphine oxide type such as 2,4,6,-trimethylbenzoylethoxydiphenyl phosphine oxide, bisacylphosphine oxides (BAPO), monoacyl and bisacyl phosphine oxides and sulphides, such as phenylbis(2,4,6-trimethylbenzoyl)-phosphine oxide (Irgacure® 819); and triacyl phosphine oxides. In some embodiments, combinations of free-radical initiators is preferred.

The initiators, including photoinitiators and/or free radical initiators, are generally present in an amount from about 0.01% to about 10% by weight relative to the total weight of the composition. In some embodiments, the total amount of photoinitiator(s) is between about 1% and 8% by weight relative to the total weight of the composition.

Curing of an epoxy group may be accelerated by addition of small quantities of an accelerator. Suitable and effective accelerators include tertiary amines, carboxylic acids and alcohols.

The chemical compositions described herein will also contain components found in conventional hard coatings, such as a binder, solvent, wetting agent, and surfactant, as examples. None of said components except some photoinitiators are provided in dry form.

A hard coating composition described herein may include a binder in the form of an acrylic monomer or oligomer, or various combinations of acrylic monomers or oligomers. The chemical composition does not include copolymers. Thus, in one or more embodiments, the hard coating composition will include an acrylic monomer or oligomer, at least a first material that is cured cationically, and a cationic initiator (such as one that is photoactivatable). The coating composition may further comprise a free radical initiator (such as one that is photoactivatable). This coating composition may further comprise one or more of the second material described above. Additionally, the coating composition (with or without the second material) may further comprise a wetting agent and a surfactant.

Useful acrylic monomers or oligomers may be monofunctional or polyfunctional. Examples of monofunctional acrylic monomers include acrylic and methacrylic esters such as ethyl acrylate, butyl acrylate, 2-hydroxypropyl acrylate, cyclohexyl acrylate, 2-ethylhexyl acrylate, methyl methacrylate, ethyl methacrylate, and the like. Preferably, it is a polyfunctional acrylic monomer (e.g., difunctional, trifunctional, and tetrafunctional monomers) containing two or three ethylenically unsaturated groups. Representative polyethylenic functional compounds containing two or three ethylenically unsaturated groups may be generally described as the acrylic acid esters and the methacrylic acid esters of aliphatic polyhydric alcohols, such as, for example, the di- and triacrylates and the di- and trimethacrylates of ethylene glycol, triethylene glycol, tetraethylene glycol, tetramethylene glycol, glycerol, diethyleneglycol, buyleneglycol, proyleneglycol, pentanediol, hexanediol, trimethylolpropane, and tripropyleneglycol. Examples of specific suitable polyethylenic-functional monomers containing two or three ethylenically unsaturated groups include trimethylolpropane triacrylate (TMPTA), tetraethylene glycol diacrylate (TTEGDA), tripropylene glycol diacrylate (TRPGDA), 1,6 hexanediol dimethacrylate (HDDMA), and hexanediol diacrylate (HDDA). Other representative examples are but are not limited to neopentylglycol diacrylate, pentaerythritol triacrylate, 1,3-butylene glycol diacrylate, trimethylolpropane trimethacrylate, 1,3-butylene glycol dimethacrylate, ethylene glycol dimethacrylate, pentaerythritol tetraacrylate, tetraethylene glycol dimethacrylate, ethylene glycol diacrylate, diethylene glycol diacrylate, glycerol diacrylate, glycerol triacrylate, 1,3-propanediol diacrylate, 1,3-propanediol dimethacrylate, 1,2,4-butanetriol trimethacrylate, 1,4-cyclohexanediol diacrylate, 1,4-cyclohexanediol dimethacrylate, pentaerythritol diacrylate, 1,5-pentanediol dimethacrylate, and the like. The acrylate may also be ethoxylated (e.g., ethoxylated pentaerythritol tetraacrylate). The acrylate may also be a urethane acrylate.

The acrylic-functional monomers and oligomers desirably are employed at a weight concentration of at least about 20% by weight, preferably from about 20% to about 90%, or from about 20% to about 85%, or from about 25% to about 80%, all on a solids basis.

Hard coat compositions described herein may further include a solvent suitable for the liquid polymerizable polymer(s) described above. Said solvent may be suitable for dispersing any of the components of the described composition, including any one or more of the first raw material, the second raw material, and binder. In some embodiments, the solvent is a polar solvent, such as any one or more of methanol, ethanol, propanol, butanol, or is a glycol, including propylene glycol, glycol monoether, and any derivative and variant thereof. Thus, a solvent may be used alone or in combination. Generally, primary alcohol and glycol ethers are included. Water is typically avoided as a solvent. In some embodiment, water is avoided as a dispersant. Ketones, acetates and aromatic solvents will swell and degrade some underlying substrates, such as substrates comprising a polycarbonate and, for these reasons are also generally avoided. In some embodiments, environmentally benign solvents are used. In some embodiments, the coating composition is substantially free of volatile solvents. Formulations having 100% solids are preferred with certain curing processes and equipment, such as those involving UV curing.

A wetting agent may be included in the described composition. The wetting agent is preferably one compatible with the binder, such as a silicone diacrylate or a silicone hexa-acrylate material (e.g., Ebecryl® 1360, last registered to AI Chem and Cy US Acquico, Inc., Delaware, US).

A low odor surfactant may also be included. In one or more embodiments, a nonionic surfactant is provided in the described hard coating composition. An example is a nonionic fluorosurfactant containing at least one fluoroalkyl or polyfluoroalkyl group, an example of which is a fluoroaliphatic polymeric ester in a glycol solvent (e.g., dipropylene glycol monomethyl ether), such as Novec™ FC-4434 (with 3M™ Company, Minnesota, US). Another example is a fluorocarbon containing organically modified polysiloxane in methoxypropanol (e.g., EFKA 3034, having 50% solids, last registered with BASF SE Company, Germany). A representative polymeric fluorocarbon compound containing 100% solids is EFKA 3600. Additional examples include but are not limited to poly(alkylenoxy)alkyl-ethers, poly(alkylenoxy)alkyl-amines, poly(alkylenoxy)alkyl-amides, polyethoxylated, polypropoxylated or polyglycerolated fatty alcohols, polyethoxylated, polypropoxylated or polyglycerolated fatty alpha-diols, polyethoxylated, polypropoxylated or polyglycerolated fatty alkylphenols and polyethoxylated, polypropoxylated or polyglycerolated fatty acids, ethoxylated acetylene diols, compounds of the block copolymer type comprising at the same time hydrophilic and hydrophobic blocks (e.g., polyoxyethylene block, polyoxypropylene blocks), copolymers of poly(oxyethylene) and poly(dimethylsiloxane) and surfactants incorporating a sorbitan group.

Pigments and/or fillers may be included when desired and for certain uses. In one or more embodiments, no pigment is used when the coating is to be clear. In some embodiments, both blue and red toners are included in a small quantity to reduce yellowing (yellowness) of the coating. Suitable pigments may include an organic and inorganic color pigment. Examples include but are not limited to titanium dioxide, iron oxide, carbon black, lampblack, zinc oxide, natural and synthetic red, yellow, toluidine and benzidine yellow, phthalocyanine blue and green, and carbazole violet, and extenders (e.g., crystalline silica, barium sulfate, magnesium silicate, calcium silicate, mica, micaceous iron oxide, calcium carbonate, zinc powder, aluminum and aluminum silicate, gypsum, and feldspar). In some embodiments, fillers may be added to enhance scratch resistance and/or abrasion resistance. For example, functionalized metal oxides may be included in amounts of up to about 25 wt. % or up to about 30 wt. % for improved abrasion resistance and increasing the refractive index of the coating.

The described hard coating compositions will be applied to a substrate. The substrate may be any substrate. In one or more embodiments, the substrate is formed from an optical material, such as an ophthalmic lens. This includes glass (inorganic or organic), and polycarbonates, for example, those made from bisphenol-A polycarbonate (e.g., LEXAN® registered to Sabic Innovation Plastics), MAKROLON® (registered to Bayer Aktiengesellschaft, Germany), or obtained by polymerization or copolymerization of diethylene glycol bis(allyl carbonate) (e.g., CR-39®, last registered to PPG Industries, Ohio, US), ORMA® (registered to Essilor International, France), as well as acrylics having an index of 1.56 (e.g., ORMUS® registered to Essilor International, France), thiourethane polymers, and episulfide polymers. Additional substrates from organic polymeric materials may be used. Additional representative examples include but are not limited to polyesters, polyamides, polyimides, acrylonitrile-styrene copolymers, styrene-acrylonitrile-butadiene copolymers, polyvinyl chloride, butyrates, polyethylene, polyolefins, epoxy resins and epoxy-fiberglass composites, to name a few.

In some embodiments, the substrate is an ophthalmic lens, such as a lens adapted namely for mounting in eyeglasses, masks, visors, helmets, goggle, other frames, etc., for protection of the eye and/or to correct vision, thus corrective or un-corrective. Such a lens may be an afocal, unifocal, bifocal, trifocal, or progressive lens. Ophthalmic lenses may be produced with traditional geometry or may be produced to be fitted to an intended frame.

In some embodiments a substrate, such as an ophthalmic lens may present with characteristics that include a high transparency, an absence of, or optionally a very low level of light scattering or haze (e.g., haze level less than 1%), a high Abbe number of greater than or equal to 30 and preferably of greater than or equal to 35, avoidance of chromatic aberrations, a low yellowing index and an absence of yellowing over time. Additionally, a substrate may exhibit a good impact strength, a good suitability for various treatments, and in particular good suitability for coloring. In some embodiments, a substrate may exhibit a glass transition temperature value of greater than or equal to 65° C., or greater than 90° C.

A substrate prepared as described herein may be further functionalized, e.g, in a further step of optionally pre-treating or post-treating the substrate. In some embodiments, the functionalization occurs prior to application of the hard coating. Functionalization may include one or more functional coatings and/or functional films. Said additional film(s) or coating(s) may be applied to either the surface to which the hard coating is applied, to an alternative surface (e.g., applied to a carrier for later transfer to the substrate) or an opposing surface. Functionalities may include, but are not limited to anti-impact, anti-abrasion, anti-soiling, anti-static, anti-reflective, anti-fog, anti-rain, self-healing, polarization, tint, photochromic, and selective wavelength filter which could be obtained through an absorption filter or reflective filter (e.g, filtering ultra-violet radiation, blue light radiation, or infra-red radiation). The functionality may be added by processes known in the art or later identified.

In some embodiments, a substrate may also be surface-treated on one or both of its opposing sides. Surface treatment will generally take place prior to providing the hard coat layer. Surface treatment will include but is not limited to an oxidation thereof or a roughening, to make said surface more adhesive to the hard coat layer or to a prior formed functionalized layer. Surface treatment may be provided by corona discharge, chromate (wet process), flame, hot air, ozone or ultraviolet ray (e.g., for oxidation), and other means for surface roughening, such as sand-blasting, or solvent treatment. In some embodiments, surface treatment includes a corona discharge method.

The described coating composition may thus be applied directly to the surface of an untreated or pre-treated substrate, to a functional surface on the substrate, or to an alternative surface (e.g., carrier) and later transferred to the substrate or its functionalized surface.

By transfer process it is understood that functionality is firstly constituted on a support like a carrier, and then is transferred from the carrier to the substrate. Thus, the carrier will include the hard coating to which an AR coating is applied. These layers when formed may then be transferred to the substrate, generally via a lamination process that may or may not require an adhesive therebetween. Lamination is defined as obtaining a permanent contact between a film which comprises at least one functionality as disclosed herein and the surface containing the substrate. Lamination may include a heating and/or polymerization step to finalize the adhesion between the layers from the carrier onto the substrate.

Application of the hard coating includes use of conventional coating and spraying methods, or by casting, brushing and the like. Coating methods when forming thin films include any of dip coating, spray coating, spin coating, gravure coating, as examples, and are usually applied in films having a thickness of about 1 to 100 micrometers or up to 500 micros. Thick films, such as floor coatings, may have a thickness up to about a few mils (understanding that 25.4 micrometers is 1 mil). If necessary, more than one layer may be applied to the surface. In some embodiments, the hard coating is formed as a UV curable hard coating for an optical or ophthalmic substrate. When the substrate is a lens for optical use, the UV curable hard coating may have a thickness that is 30 micrometers or less.

Cure temperature should typically attain near or at the glass transition temperature (T_{g}) of the fully cured network in order to achieve maximum properties. In some embodiments, temperature may also be increased in a step-wise fashion to control the rate of curing and prevent excessive heat build-up from the exothermic reaction. For UV curable coatings in optical applications, the UV curing will include UV curing devices (e.g., bulbs) that provide infrared (IR) radiation, and thereby provide heat. This is important for the described chemical compositions as they possess—OH groups; the heat is important for promoting some condensation between the —OH groups. However, it is not be desirable to fully condense the free —OH groups prior to deposition of an anti-reflective (AR) coating, as there would be nothing for the AR coating to interact and/or bond with.

Cure time for optical purposes typically allows some degree of unsaturation after cure, such that some monomer remains uncured. For optical purposes, this is important because over curing of a described hard coating has been found to lead to poor adhesion of the AR coating applied thereon.

The described coating compositions when cured form a hard coating to which an anti-reflective (AR) coating will adhere to. Adherence is strong and robust. Generally and importantly, in one or more embodiments there will be an absence of a primer or adhesive layer between any of the described hard coating and an AR coating. Thus, an AR coating is directly deposited onto the described hard coating.

Application of the AR coating may include application of one layer, two layers or a plurality of layers, also referred to as a stack of layers. The AR layer will be one that improves the anti-reflective properties of the finished substrate over all or a portion of the visible spectrum, increasing the transmission of light at said all or portion of the visible spectrum and reducing surface reflectance at the interface between the surface of the AR coating and air. Generally, the AR coating comprises one or more dielectric materials selected from a metal oxide, a metal nitride, and a metal nitride oxide. Representative examples including but are not limited to SiO₂, MgF₂, ZrF₄, AlF₃, chiolite (Na₃Al₃F₁₄]), cryolite (Na₃[AlF₆]), TiO₂, PrTiO₃, LaTiO₃, ZrO₂, Ta₂O₅, Y₂O₃, Ce₂O₃, La₂O₃, DY₂O₅, Nd₂O₅, HfO₂, Sc₂O₃, Pr₂O₃, Al₂O₃, Si₃N₄. The dielectric material may also comprise a silicon based polymeric dielectric.

In some embodiments, the AR coating will comprise alternating layers of different refractive indexes. In some embodiments, a first layer will have a low refractive index (LRI). A second layer may have a medium refractive index (MRI) or a high refractive index (HRI). For example, an LRI layer may have a refractive index of 1.55 or less, or lower than 1.50, or lower than 1.45 (the refractive index is based on a reference wavelength of 550 nm when obtained at an ambient temperature, or at about 25 degrees C.). An HRI layer may have a refractive index higher than 1.55, or higher than 1.6, or higher than 1.8, or higher than 2 (the refractive index is based on a reference wavelength of 550 nm when obtained at an ambient temperature, or at about 25 degrees C.). An HRI layer may comprise, without limitation, one or more mineral oxides such as TiO₂, PrTiO₃, LaTiO₃, ZrO₂, Ta₂O₅, Y₂O₃, Ce₂O₃, La₂O₃, Dy₂O₅, Nd₂O₅, HfO₂, Sc₂O₃, Pr₂O₃ or Al₂O₃, and Si₃N₄, as well as various mixtures. In some embodiments, the HRI layer is a silicon containing material. In some embodiments, the HRI layer is silicon nitride. An LRI layer may comprise, without limitation, one or more of SiO₂, MgF₂, ZrF₄, AlF₃, chiolite (Na₃Al₃F₁₄]), cryolite (Na₃[AlF₆]), and various mixtures or doped variations thereof, including SiO₂ or SiO₂ doped with Al₂O₃, fluorine, or carbon, as examples. In some embodiments, the LRI layer is a silicon containing material. In some embodiments, the LRI layer is silicon oxide. The total physical thickness of the AR coating is generally higher than 100 nm, or higher than 150 nm, and may be up to 200 nm thick, or up to 250 nm thick, up to 500 nm thick or up to 1 micrometer thick

Said AR coating may comprise three or more dielectric material layers of alternating refractive indexes. In some embodiments, the deposition includes alternating layers of HRI and LRI layers, comprising silicon nitride and silicon oxide, respectively.

The AR coating is generally applied by vacuum deposition. In some embodiments, the surface to be coated receives a mild plasma cleaning prior to the deposition performed by sputtering. Generally, the plasma cleaning or etching step is a surface preparation for the hard coatings described herein. The plasma cleaning generally includes an Argon (Ar) plasma with no reactive gases, for cleaning, removing cleans dust, dirt, volatiles, etc., from the surface of the hard coating.

Processes for applying the AR coating may include evaporation (optionally assisted by ion beam deposition), ion-beam spraying, cathodic spraying, or chemical vapor deposition (optionally assisted by plasma treatment). Sputter coating machines are used to provide the reactive or functional dielectric material. When the dielectric is a metal oxide, it is often formed by an atmospheric pressure plasma treatment. The process may include inducing discharge between opposed electrodes at atmospheric pressure or near atmospheric pressure, exciting a reactive gas to a plasma state, and exposing the hard coating film to the reactive gas in the plasma state to form a metal oxide, a metal nitride, or a metal nitride oxide layer on the hard coating film. The reactive gas is a metal compound with a hydrogen gas, an oxygen gas or a carbon dioxide gas, and further containing a component selected from oxygen, ozone, hydrogen peroxide, carbon dioxide, carbon monoxide, hydrogen and nitrogen in an amount of 0.01 to 5% by volume.

The AR coating may further comprise a sub-layer, which may be considered part of the AR coating, but may have a relatively higher or lower thickness than the HRI or LRI layers. In some embodiments, the sub layer is a thin layer of SiO₂ that is of a thickness anywhere between 1 nm to 50 nm thick.

The hard coating compositions described herein have been provided with chemical compositions having specific first raw materials and optionally specific second raw materials that greatly increase the presence of hydroxyl groups in the formulation and increase the number of unreacted hydroxyl groups in the hard coating composition upon curing. The increased presence of the hydroxyl groups directly influence adherence of the sputter applied AR coating to the cured hard coating composition. Without being bound by theory, the increased presence of hydroxyl groups in the hard composition provides the ability to improve cross-linking in the cross linking composition and to withstand the high compressive stress of the AR coating when applied by sputtering. In addition, the increased presence of unreacted hydroxyl groups in said composition when cured provides adherence sites with the AR coating when applied by sputtering. Overall, the described hard coating compositions enhanced adherence between the AR coating and the hard coating. Said increased adherence was found to provide significant increases in performance as measured by an adhesion test, which included withstanding the highest number of rubs in the performance test of adherence. Representative findings are provided below.

Hard coating compositions were prepared with at least one first raw material. Some hard coat compositions included two or three first raw materials. Some hard coating compositions further included at least one second raw material. The described hard coatings were formulated as 100% solids or solvent-borne. Hard coating compositions were applied to a polycarbonate (thermoplastic) substrate or a copolymerized diethylene glycol bis(allyl carbonate) (thermoset) substrate. The substrates were provided in the form of either a semi-finished polycarbonate lens or finished single vision lens (copolymerized diethylene glycol bis(allyl carbonate). For the polycarbonate lenses, they had been dip coated in one of several thermally cured hard coatings including, but not limited to NTPC or PDQ, and then surfaced to either plano (0.00) or −2.00 power, followed by application of a UV curable coating composition described herein to the concave surfaced side, which was then followed by application thereon of the sputter AR coating. For the CR-39 finished single vision lenses, to an uncoated surface on the convex side the UV curable coating composition described herein was applied followed by, in some instances, application thereon of the sputter AR coating. The ones that were not further applied with the sputtered AR coating were evaluated for mechanical performance of the described hard coating. The mechanical performances include Bayer abrasion, hand steel wool, Haze, and transmission, among other tests. These substrate, coated with described coating compositions were compared and contrasted with a copolymerized diethylene glycol bis(allyl carbonate) (thermoset) substrate having a conventional hard coating (e.g., absent the first and/or second raw materials) provided as a finished single vision lens.

The hard coatings described herein were generally prepared by blending together the listed ingredients, amounts being given in wt % and % solids. The blended hard coating compositions were applied by spin coating onto a surface of the lens substrate as described above. The hard coatings were applied as films having a thickness of anywhere between about 1 micrometer and 9 micrometers or between about 2 micrometers and 7 micrometers. Hard coating films were cured by UV radiation. Upon curing, the hard-coated lenses were allowed to rest, generally overnight, and then subjected to pretreatments prior to sputter coating. The pretreatments included washing with a mild detergent followed by air drying, chemical treatment, and plasma treatment. The chemical treatment was a mild caustic detergent wash (comprising dilute NaOH) in an ultrasonic environment, followed by neutralization with a dilute acid solution (comprising 5% acetic acid) in an ultrasonic environment and then a water rinse (e.g., deionized water). After chemical treatment, lenses were baked for about 1 hr. at about 60° C. to remove absorbed water. The plasma treatment is described above and was performed prior to sputtering. AR coatings were then deposited on the pretreated hard coating surface by sputtering using a sputter coating machine. The AR coating included the following layers in order: HRI of 34 nm, LRI of 22 nm, HRI of 76 nm, and LRI of 88 nm. On average, the total thickness of the AR stack was about 220 nm.

Adherence between a sputtered AR coating and a described hard coating was found to be improved with pretreatment performed prior to deposition of the AR coating. For example, a pretreatment using the chemical cleaning method described above was found to improve adherence of the AR coating as compared with plasma treatment that included a soap and water prewash. Thus, in one or more embodiments, a substrate having the described hard coating composition may be initially pretreated by any of the chemical cleaning method, soap and water, and/or plasma treatment prior to deposition of an AR coating.

For the representative examples presented below, the same AR coating was applied to each lens that had a hard coating composition described herein (that had initially undergone pretreatment), or a control coating that had been pretreated.

Each AR coating in the examples presented below included a first layer of silicon nitride (an HRI layer), a second layer of silicon oxide (a LRI layer), a third layer of silicon nitride, and a fourth layer of silicon oxide. The first layer was deposited directly on the hard coating composition or the control coating. All AR coating layers were deposited using an SP200 sputter coater. As such, any performance differences between the representative hard coatings and control hard coatings are attributable to the hard coating chemistry described herein.

Performance was assessed by an N×10 blows test that evaluated the adherence of the sputtered AR coating to the hard coating composition (either as represented herein or provided as a control) following increasing numbers of mechanical rubs. The N×10 blow test was evaluated by mechanically rubbing the AR coating surface with a cloth soaked in isopropyl alcohol under pressure. Each lens was inspected after every 30 complete cycles (n=3), in which each cycle is a back and forth motion. If the AR coating or a portion thereof was removed, a score of N=3 was received after the first 30 cycles. If no AR coating was removed, the test continued. If the AR coating was removed after 60 cycles, a score of N=6 was received. If no AR coating was removed, the test continued. If the AR coating was removed after 90 cycles, a score of N=9 was received. If no AR coating was removed, the test continued. If no AR coating was removed after 120 cycles, a score of N>12 was received, and the AR coating was considered to have passed the N×10 blows test. This was considered to be a good adherence of the applied AR coating to the hard coating.

To evaluate good adherence versus a more robust adherence, the adherence or rub test could be continued for more than 500 cycles (N>50). This is not without undue experimentation, as it is time consuming and labor intensive; however, it is a proper way to evaluate incremental differences in adherence, especially between current or conventional coatings (some of which may exhibit some good or modest adherence) as compared with the chemical coating compositions that have been described herein (all of which demonstrated robust adherence).

TABLES 1A and 1B depict representative hard coating compositions (R1, R2, R3) having two or more of the raw materials as described herein, which when prepared as described and applied by spin coating to a substrate, were each found to improve adherence of a sputtered AR coating applied thereon as compared with comparative control hard coatings (C1, C2, C3) lacking said at least two raw materials. As shown in TABLE 1, R1, R2 and R3 each withstood and remained adherent even after the highest number of rubs (N×10, in which N was greater than 50) as compared with the control coatings that were no longer adherent after N=3 (C2 and C3) or N=9 rubs (C1). A second material alone in a comparative control hard coating (C2 or C3) was not sufficient to provide robust adherence with an AR coating.

In TABLES 1A, 1B, and 2, the first raw material (A or B) was an unhydrolyzed alkoxysilane monomer in the form of glycidoxypropyltrimethoxysilane (A) or vinyltrimethoxysilane (B). The second raw material (A or B) was silicon oxide particles dispersed in an acrylic monomer (A, approximately 50 wt. % in pentaerythritoltetraacrylate) or dispersed in a solvent (B, approximately 30 wt. % in a glycol ether, such as propylene glycol methyl ether). The acrylate was provided as one or more of pentaerythritol tri- and tetra- acrylate (A), pentaerythritol triacrylate (B), or ethoxylated pentaerythritol tetraacrylate (C). The wetting agent was an acrylated silicone slip agent. The solvents were in the form of a glycol ether (A), such as propylene glycol methyl ether, and 1-propanol (B). The surfactant was a fluoroaliphatic polymeric ester in a glycol solvent (approximately 50 wt. %). The initiators included cationic photoinitiators in the form of onium salt catalysis (A or B, as triarylsulfoniumhexafluorophosphate, and triarylsulfoniumhexafluoroantimonate, respectively) and/or free radical photoinitators (C or D, as 2-hydroxy-2-methyl-1-phenyl-1-propanone [Darocur® 1173, registered with BASF SE Company, Germany] or phenylbis(2,4,2-trimethoxybenzoyl)-phosphine oxide) [Irgacure 819], respectively).

TABLE 2 shows that neither a conventional acrylate hard coating (C4) or an acrylate hard coating comprising only about 11% (based on the total composition, or 19% of total solids, no solvent) of an unhydrolyzed alkoxysilane monomer (C5) were capable of promoting a robust adherence with the AR coating. Robust adherence was only found in representative hard coating compositions R4 and R5, each including two first raw materials in their formulation, with an unhydrolyzed alkoxysilane monomer of about 19% (based on the total composition, or 32% of total solids, no solvent).

Additional representative unhydrolyzed alkoxysilane monomer are depicted in TABLE 3, as first raw materials C, and D, in the form of trivinylethoxysilane, and 2-(3,4-epoxycyclohexyl)ethyltrimethoxy silane, respectively. The first raw materials A and B, the acrylates, solvents, wetting agent, initiators, and surfactant are as described above for TABLES 1 and 2. The substitute-A for the first raw material was hexavinyldisiloxane, which is not an unhydrolyzed alkoxysilane as described herein, was substituted for one of B or C in formulation C6, which accounts for the inability of C6 to achieve a robust adherence with the AR coating applied thereon. C6 contained only 13% of the unhydrolyzed alkoxysilane (based on the total composition, or 21.3% of total solids, no solvent). All of the formulations, R6, R7, and R8 were sufficiently formulated, such that there was robust adherence with the AR coating applied thereon, N>50 when measured by the adherence test.

TABLE 4 provides additional examples of robust adherence of the AR coating with a hard coating described herein (R10, R11, R12) regardless of the source, as long as there was at least one first raw material (R10, in which the first raw material was glycidoxypropyltrimethoxysilane), or there could be two first raw materials (R11, in which the first raw materials were glycidoxypropyltrimethoxysilane and vinyltrimethoxysilane), or there could be two first raw materials with one second raw material (R12, in which the first raw materials were glycidoxypropyltrimethoxysilane and vinyltrimethoxysilane, and the second raw material C was 50 wt. % silicon oxide containing nanoparticles provided in a base resin of trimethylolpropanetriacrylate).

In TABLE 5, one of the first raw materials was replaced by a substitute —B, or methyltriethoxysilane (formulation C7), which is also not an unhydrolyzed alkoxysilane as described herein because the methyl group is not reactive. Said composition (C7) was compared with one comprising two first raw materials (A+B, R13) or one comprising a first raw material with a second raw material (R14). The second raw material (E) was in the form of trimethylolpropanetriglycidyl ether). Acrylate D was a urethane acrylate, included in R14 and in the comparative control (C7). The first raw materials A and B, the acrylates, solvents, wetting agent, initiators, and surfactant are as described above for TABLES 1 and 2. Both R13 and R14 promoted robust adherence with the AR coating applied thereon (N>50), when measured by the adherence test. Increasing the amount of the second raw material allowed for a decrease in the first material; however, the first material cannot be replaced by the raw second material, as an amount of the first raw material is needed in order to achieve robust adherence with an AR coating when applied by sputtering to the described hard coating.

Increasing the amount of a second raw material in a hard coating as a means for replacing the first raw material did not promote robust adherence of an AR coating to the cured hard coating. Thus, as depicted in TABLE 6, while an AR coating exhibited robust adherence to representative hard coating R15, which included first raw materials glycidoxypropyltrimethoxysilane (A) and vinyltrimethoxysilane (B), when these raw materials were essentially replaced in a comparative control (C8) by second raw material-B, adherence dropped significantly (N=3 for C8). Only poor adhesion was observed after deposition of the AR coating to C8. This is contrasted with robust adhesion of the AR coating to R15. This illustrates that it is not simply the total —OH concentration that is important for robust adhesion. The coating components must be able to covalently bond to both the AR coating and to each other. In one or more embodiments, at least a minimum amount of about 9.0%, or about 9.1%, or about 9.2%, or about 9.3%, or about 9.4% of a multifunctional alkoxysilane, such as an epoxyalkoxy silane or vinyl alkoxysilane, is necessary for robust adherence with an AR coating when applied by sputtering to the described hard coating.

Similar findings are disclosed in TABLE 7, in which representative hard coating (R16) contains first raw materials A and B and second raw material A as compared with comparative control (C9) having similar components without said first raw materials but an increased amount of second raw material A. The solvent amount was increased in C9 to maintain the solids amount. Only cationic initiators were included. TABLE 7 reinforces the findings that it is not just the total amount of —OH groups in the composition, but that there is critical amount of first raw material to provide a more robust adherence when said coating is sputter coated with an AR coating described herein.

TABLE 8 shows another representative hard coating containing only first raw materials A and B (R17) as compared with comparative control (C10) having similar components without said first raw materials. The solvent amount was increased in C10 to maintain the solids amount. Again, a second raw material is not sufficient to replace one or more first raw materials.

Further examples are depicted in TABLE 9.

As disclosed, through a variety of sources of hydroxyl groups (or hydroxyl group function) provided by addition of one or more first raw materials with and without addition of second raw materials, total hydroxyl groups were increased in the described hard coating compositions and when increased, the hard coating compositions described herein unexpectedly and successfully promoted robust adherence of a sputter applied antireflective coating. Comparative control hard coatings, similar to conventional hard coating compositions, were unable to support adherence as reported by the poor adherence or rub test performances disclosed herein.

While the AR coatings herein included alternating high and low index layers of silicon nitride and silicon oxide, other AR coating layers would also be appropriate. The significant improvement in adherence were found when the raw materials were in the form of epoxy alkoxy silanes, cycloaliphatic epoxy silanes, aliphatic epoxies, vinyl silanes, particles containing silicon oxide (dispersed in solvent or in acrylic monomers or in cycloaliphatic epoxies), and combinations thereof.

FTIR analysis confirmed the increased presence of —OH groups in hard coatings containing the raw materials presented above, in comparison with the comparative control coatings formulated without said raw materials, and suggests a possible role in their interaction between the hard coatings and the sputtered AR coating. A summary of some of FTIR findings when performed on representative coatings in solution (as a liquid) and when cured are provided in TABLE 10.

TABLE 10

| | | C═O | C═C—H | | Relative | Perfor- |
|---|---|---|---|---|---|---|
| Sample | | (cm⁻¹) | (cm⁻¹) | Ratio | to C═O | mance |
| R17 | solution | 0.078 | 0.078 | 1:1 | 1:1 | robust |
| | cured | 0.039 | — | 1:0 | 1:0 | |
| C10 | solution | 0.102 | 0.062 | 1.6:1 | 1:0.63 | poor |
| | cured | 0.119 | 0.017 | 7:1 | 1:0.14 | |
| R15 | solution | 0.050 | 0.050 | 1:1 | 1:1 | robust |
| | cured | 0.025 | 0.023 | 1.1:1 | 1:0.91 | |
| C8 | solution | 0.118 | 0.079 | 1.5:1 | 1:0.67 | poor |
| | cured | 0.097 | 0.029 | 3.3:1 | 1:0.30 | |
| R16 | solution | 0.108 | 0.106 | 1.7:1 | 1:1 | robust |
| | cured | 0.038 | 0.022 | 1:1 | 1:0.59 | |
| C9 | solution | 0.117 | 0.074 | 1.6:1 | 1:0.63 | poor |
| | cured | 0.080 | 0.021 | 3.8:1 | 1:0.26 | |

FTIR attenuated total reflectance (ATR) spectra of the coated substrates (cured) and liquid compositions (solution) were obtained from the co-addition of 4 scans at 4 cm⁻¹ resolution on a Perkin Elmer Spectrum 100 equipped with a Spectra-Tech Thunderdome single reflection ATR accessory, using a germanium crystal. Probe depth using this accessory was about 0.5 microns and the sampling area was about 2 mm in diameter. Liquid samples were directly dropped on the ATR Ge crystal for FTIR spectra collection (solution). Four independent areas on the uppermost surface of the coated lens substrates (cured hard coating followed by deposition of the AR coating) were also analyzed using ATR-FTIR. All reported spectra were averaged from at least the 4 sample spectra. Data were imported into Grams/32 for spectral analysis.

Peak intensities for Si—OH regions were found to correlate with overall performance of the hard coating, in which the peak intensity was greater in robust performing hard coatings (ones described herein). These findings are summarized in TABLE 11.

TABLE 11

| | —OH peak intensity | Position v | |
|---|---|---|---|
| Sample | (Abs) | (cm⁻¹) | Performance |
| R17 | 0.014 | 3397 | robust |
| C10 | 0.009 | 3470 | poor |
| R15 | 0.010 | 3470 | robust |
| C8 | 0.006 | 3470 | poor |
| R16 | 0.010 | 3470 | robust |
| C9 | 0.005 | 3470 | poor |

TABLE 12 summarizes the components in the hard coating chemical compositions that were analyzed by FTIR.

TABLE 12

| Components | R17 | C10 | R15 | C8 | R16 | C9 |
|---|---|---|---|---|---|---|
| first raw material—A | Y | — | Y | — | Y | — |
| first raw material—B | Y | — | Y | — | Y | — |
| second raw material—A | — | — | — | — | Y | Y |
| second raw material—B | — | — | Y | Y | — | — |
| acrylate A + B | Y | Y | Y | Y | Y | Y |
| acrylateC | Y | Y | Y | Y | — | — |
| solventA | Y | Y | — | — | Y | Y |
| solventB | Y | Y | Y | Y | Y | Y |
| wetting agent | Y | Y | Y | Y | Y | Y |
| cationic initiators | Y | — | Y | — | Y | — |
| surfactant | Y | Y | Y | Y | Y | Y |

The coating compositions described herein are suitable for use on substrates that are transparent as well as non-transparent, or that that are not fully transparent. Said coating compositions may form very thin films, thick films, and may be coated in a plurality of layers, as desired.

As used herein, the words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps.

When values are given it is understood that any of said numeric value may be considered to be about said numeric value.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values, including the values “a” and “b” themselves. Terms such as “first,” “second,” “third,” etc. may be arbitrarily assigned and are merely intended to differentiate between two or more components, parts, or steps that are otherwise similar or corresponding in nature, structure, function, or action. For example, the words “first” and “second” serve no other purpose and are not part of the name or description of the following name or descriptive terms. The mere use of the term “first” does not mean that there any “second” similar or corresponding components, parts, or steps. Similarly, the mere use of the word “second” does not mean that there be any “first” or “third” similar or corresponding component, part, or step. Further, it is to be understood that the mere use of the term “first” does not mean that the element or step be the very first in any sequence, but merely that it is at least one of the elements or steps. Similarly, the mere use of the terms “first” and “second” does not mean any sequence. Accordingly, the mere use of such terms does not exclude intervening elements or steps between the “first” and “second” elements or steps.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope of the present invention. The various elements or steps according to the disclosed elements or steps can be combined advantageously or practiced together in various combinations or sub-combinations of elements or sequences of steps to increase the efficiency and benefits that can be obtained from the invention.

It will be appreciated that one or more of the above embodiments may be combined with one or more of the other embodiments, unless explicitly stated otherwise. The invention illustratively disclosed herein suitably may be practiced in the absence of any element or step that is not specifically disclosed or claimed. Furthermore, no limitations are intended to the details of construction, composition, design, or steps herein shown, other than as described in the claims.

1. An ophthalmic article comprising at least a first layer as a hard coating to which is adhered a sputtered silicon containing layer, wherein the first layer is formed with an unhydrolyzed alkoxysilane monomer cured cationically to increase a total amount of hydroxyl functional groups available in the first layer upon curing, the increased hydroxyl functional groups for interacting with the sputtered silicon containing layer and promoting adherence between said layers.

2. The ophthalmic article of claim 1, wherein the unhydrolyzed alkoxysilane monomer cured cationically includes at least one reactive group as an epoxy alkoxy silane, cycloaliphatic epoxy silane, and vinyl alkoxy silane.

3. The ophthalmic article of claim 1, wherein the hydroxyl functional groups are further provided by a second material comprising one or more of silicon oxide particles and an aliphatic epoxy.

4. The ophthalmic article of claim 1, wherein the hard coating is formed from a composition comprising the unhydrolyzed alkoxysilane monomer cured cationically, an acrylic monomer and a free radical initiator that is photoactivatable.

5. The ophthalmic article of claim 1, wherein the sputtered silicon containing layer is a multi-layer antireflective coating.

6. The ophthalmic article of claim 1, wherein the unhydrolyzed alkoxysilane monomer is in an amount that is at least about 5 wt. % or greater and up to about 60 wt. %.

7. The ophthalmic article of claim 1, wherein the sputtered silicon containing layer in contact with the hard coating is silicon nitride or silicon oxide.

8. A composition provided as a hard coating for an ophthalmic article and for promoting adhesion with a sputtered silicon containing layer applied thereto, the composition comprising:
an acrylic monomer;
a first material as a source of hydroxyl functional groups when the composition is cured, the first material comprising an unhydrolyzed alkoxysilane monomer cured cationically and in an amount that increases a total amount of hydroxyl functional groups in the composition;
a cationic initiator that is photoactivatable; and
optionally a second material as a source of further hydroxyl functional groups for the composition upon curing, the second material including one or more of silicon oxide particles and an aliphatic epoxy.

9. The composition of claim 8, wherein the unhydrolyzed alkoxysilane monomer includes at least one of an epoxy alkoxy silane, cycloaliphatic epoxy silane, and vinyl alkoxy silane.

10. The composition of claim 8 further comprising a free radical initiator that is photoactivatable.

11. The composition of claim 8, wherein the sputtered silicon containing layer is a stack of light absorptive antireflective layers in which a layer in immediate contact with the hard coating is silicon nitride.

12. The composition of claim 8, wherein the first material is in an amount that is at least about 5 wt. % or greater and up to about 60 wt. %.

13. The composition of claim 8, wherein the second material when provided is in an amount of up to about 30 wt. %.

14. The composition of claim 8, wherein the silicon oxide particles are provided as a dispersion, and the dispersion comprises any one or more of a group selected from a solvent, an acrylic monomer, and an epoxy monomer.

15. A method of promoting adherence of a sputtered silicon containing layer to a first layer as a hard coating by including an unhydrolyzed alkoxysilane monomer cured cationically in a composition forming the hard coating and increasing a total amount of hydroxyl functional groups in the composition upon curing, the increased hydroxyl functional groups interacting with the sputtered silicon containing layer and promoting adherence there between.
